(19) United States
(12) Patent Application Publication
(10) Pub. No.: US 2020/0343661 A1
(43) Pub. Date: Oct. 29, 2020

(54) CARD EDGE CONNECTOR WITH IMPROVED ENGAGEMENT OF GROUND CONTACTS AND GROUND PLATE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: KUI WU, Kunshan (CN); XIAO-HU YIN, Huaian (CN); GUO-XIANG NIU, Huaian (CN); WEN-JUN TANG, Kunshan (CN)

(21) Appl. No.: 16/857,656

(22) Filed: Apr. 24, 2020

(30) Foreign Application Priority Data
Apr. 24, 2019 (CN) 201910334435.2

(51) Int. Cl. H01R 12/72; H01R 13/11

(52) U.S. Cl. CPC H01R 12/721; H01R 13/11

(57) ABSTRACT

A card edge connector includes an elongated housing comprising opposite long walls and defining a card slot between the long walls, two rows of contacts retained in the long walls respectively and a ground member including two long plates retained in the long walls respectively. Each row of contacts includes ground contacts and signal contacts, the ground contacts comprises retaining sections retained in the housing, elastic sections extending upward from the retained sections with mating portions exposed to the card slot and leg sections extending downward from the retaining sections. Each of the ground contacts further comprises an engaging portion curved from the elastic section and touching corresponding long plate.

### BACKGROUND OF THE INVENTION

### 1. Field of the Invention

The present invention relates generally to a card edge connector, and more particularly to a card edge connector having an engagement of ground contacts and a ground plate.

### 2. Description of Related Arts

U.S. Ser. No. 10/581,206B discloses a card edge connector which includes an insulating housing, contacts ad a ground member retained in the housing. The ground member includes two ground plates, each long plate defines a plurality of elastic fingers from an upper edge thereof and pressing against the ground plate. It can be seen that the distance between the ground contacts and the ground plate is limited to be small, the length of the finger is limited and the top arc portions of the fingers can be easily damaged.

An improved card edge connector is desired.

### SUMMARY OF THE INVENTION

An object of the invention is to provide a card edge connector, the connector comprises an elongated housing comprising opposite long walls and defining a card slot between the long walls, two rows of contacts retained in the long walls respectively and a ground member comprising two long plates retained in the long walls respectively. Each row of contacts comprises ground contacts and signal contacts. The ground contacts comprise retaining sections retained in the housing, elastic sections extending upward from the retained sections with mating portions exposed to the card slot and leg sections extending downward from the retaining sections. Each of the ground contacts further comprises an engaging portion curved from the elastic section and touching corresponding long plate.

### BRIEF DESCRIPTION OF THE DRAWING

FIG. 1 is a perspective view of a card edge connector according to a preferred embodiment of the invention;

FIG. 2 is another perspective view of the card edge connector in FIG. 1;

FIG. 3 is an exploded perspective view of the card edge connector in FIG. 2;

FIG. 4 is an enlarged exploded perspective of parts of the card edge connector of FIG. 3;

FIG. 5 is an exploded perspective view of contacts and ground member in FIG. 1;

FIG. 6 is a side view of the contacts and the ground member in FIG. 5;

FIG. 7 is a perspective view of four contacts in FIG. 5;

FIG. 8 is a sectional view of the card edge connector FIG. 1 taken broken lines 8-8; and

FIG. 9 is a sectional view of parts of the card edge connector FIG. 1 taken broken lines 9-9.

### DETAILED DESCRIPTION OF THE PREFERRED EMBODIMENT

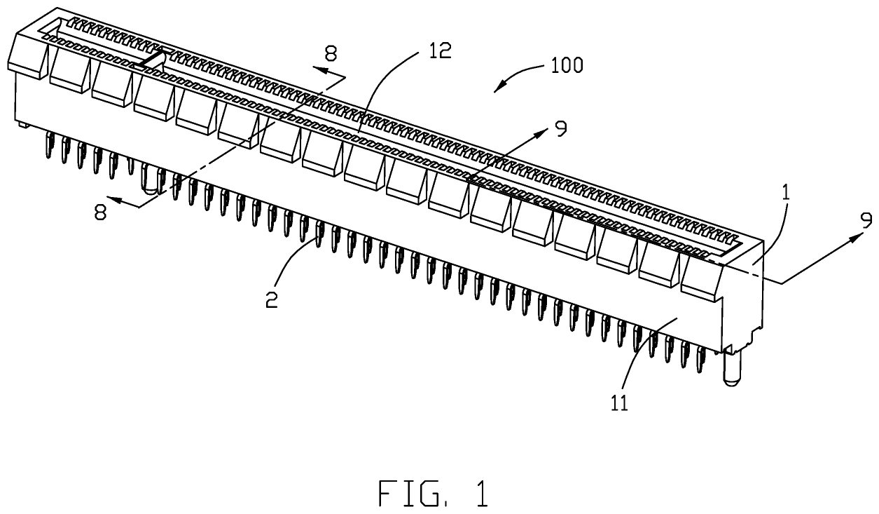

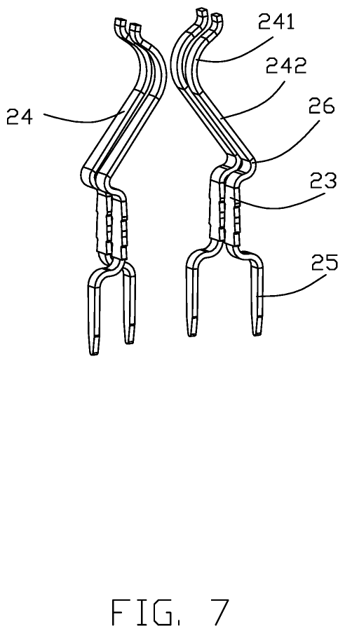

Referring to FIGS. 1-9, an embodiment of this present invention is a card edge connector 100, which includes an elongate housing 1 made from insulating material, conductive contacts 2 retained in the housing 1 and a ground member 3. The housing 1 defines two opposite long/side walls 11 with a card (receiving) slot 12 between the long walls 11 and two opposite short/end walls 13 and a bottom wall 14 connecting with the long walls 11 and short walls 13. The contacts 2 are arranged in two rows and each include ground contacts 21 and signal contacts 22. In this embodiment, these two kinds of contacts have a same construction. The ground contact 21 includes a retaining section 23 retained in the housing, an elastic section 24 extending upward and with an arc mating portion or contacting section 241 extending into the card slot 12, and a leg section 25 extending downward and out the housing. The ground contact 21 further defines an engaging portion 26 for engagement with the ground member 3, the engaging portion 26 is curved from the elastic section 24.

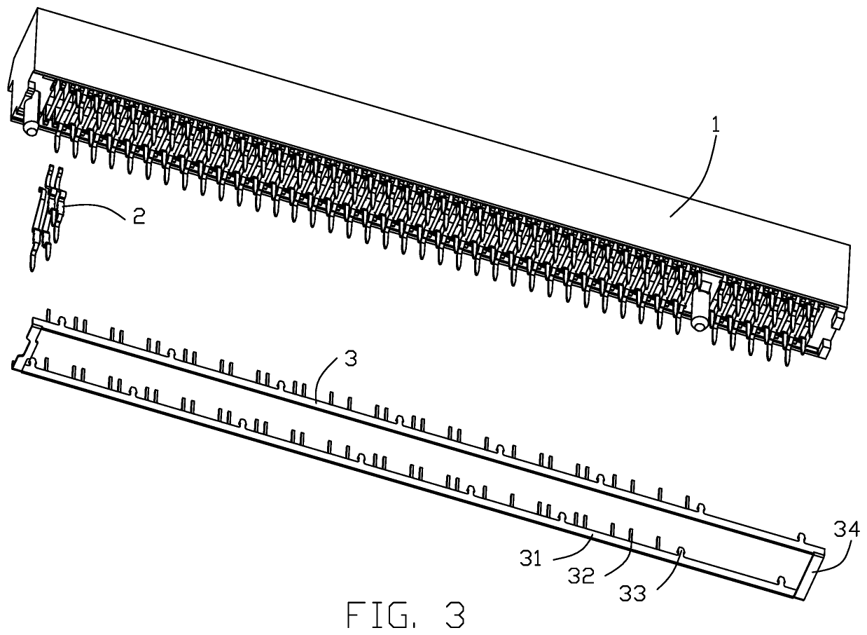

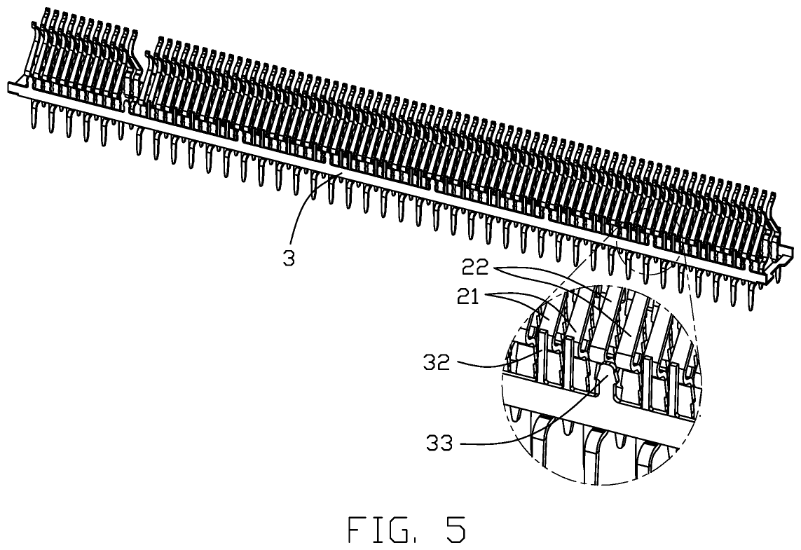

Referring to FIGS. 3 and 5, the ground member 3 includes two long/ground plates/bars 31 retained in long walls respectively and a plurality of upright sections 32 extending from an upper edge of each long wall 31. The engaging portions 26 press against the upright sections 32 one by one. The ground member 3 further defines at least one retaining ribs 33 upwards from the upper edge of the long wall 31, and the retaining ribs 33 are interfered with the long wall 11. The width of the upright section 32 in an elongate direction are smaller than that of the retaining section 33, while a height of the upright section 32 is larger than that of the retaining section 33 in an upright direction. Understandingly, the engaging portions 26 are arc and the upright sections 32 are linear, so that the ground member 3 is simple compared with the traditional grounding member requisitely forming deflectable spring tangs engaged with the corresponding grounding contacts.

The elastic sections 24 include the engaging portions 26 slating outward from the retaining sections 23, linear portions 241 slanting inwards from the engaging portions 26 and the mating portions 21 extending from the linear portions 241. The upper end of each engaging portion 26 unitarily connects the lower end of the elastic section 24 and the lower end of each engaging portion 26 connects the upper end of the retaining section 23. The engaging portion 26 extends from the upper edge of the retaining section 23 and slant towards the long plate 31. From a top view, the engaging portions 26 and the elastic sections 24 are located at opposite sides of the retaining sections 23. The arc shape engaging portion 26 lengthens the contact, thereby enhancing deformation performance of the ground contacts. The elastic sections 24 will be pushed outwards in a transverse direction when a card is inserted in the card slot 11, and cause an outward force of the engaging portions 24 to enhance an engagement between the engaging portions 26 and the upright sections 32. Please noted, pressing points of the engaging portions 26 and the long plates 31 also functions as pivot points of the elastic sections 24 rotating outwards when the card is inserted in the card slot 11.

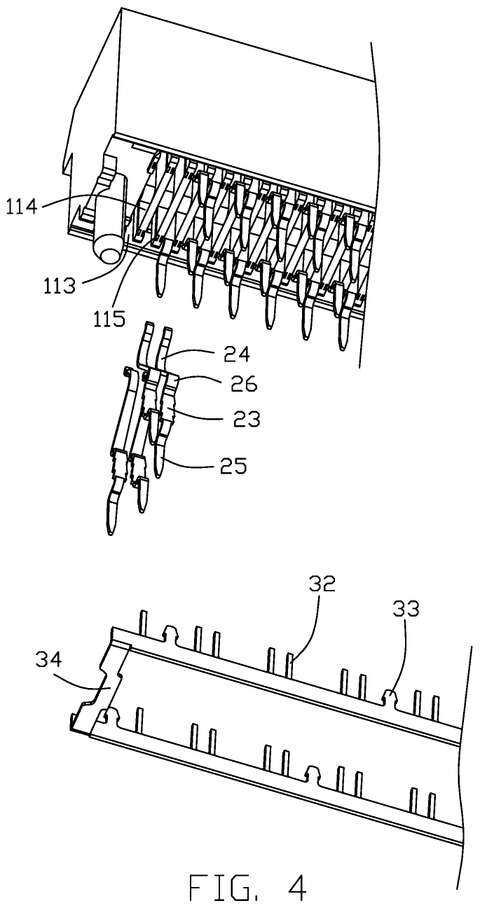

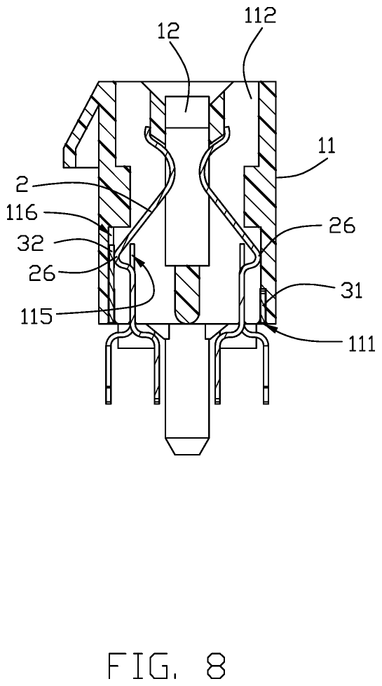

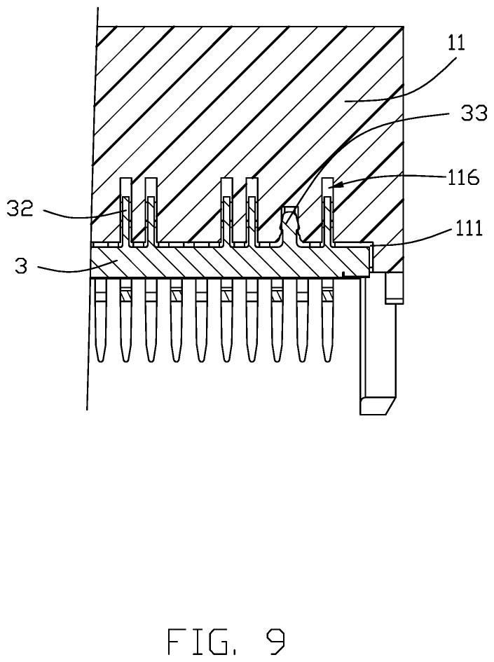

Referring to FIGS. 8-9, each of the long walls 11 defines a receiving slot 111, and the long plate 31 is inserted in the receiving slot 111. The retaining sections 33 are located between but disconnect with two adjacent contacts 2 as best shown in FIG. 5. The long walls 11 define grooves/passageways 112 and the contacts 2 are received in the grooves 112. Each groove 112 defines side face 113 extending along the elongated direction and the upright direction, and two end faces 114 extending along the transverse direction and the upright direction as best shown in FIG. 4. The retaining sections 23 are retained in slots 115 defined on end faces 114 and separate from the side face 113. The housing 1 further forms a plurality of slits 116 communicatively aligned with the receiving slot 111 to receive the corresponding upright sections 32, respectively. The long wall 11 forms a plurality of protrusions in the corresponding grooves 112 wherein the elastic section 24 may abut against the protrusion at position P (FIG. 8) when the card is inserted within the card slot 12 so as to reinforce the reaction of the contact during mating.

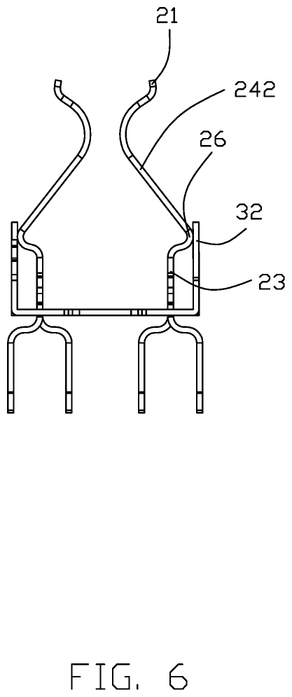

In this embodiment, the signal contacts 22 and the ground contacts 21 share a same construct, that is the signal contacts also have engaging portions 26. Referring to FIG. 5, the ground member 3 defined no upright sections 32 so that the engaging portions 26 of signal contacts 221 directly abut against the corresponding side faces 113. Referring to FIG. 6, a pair of ground contacts 21 and a pair of differential signal contacts 22 are arranged alternately, and the long plates 31 defines no upright sections aligned with the engaging portions 26 of the signal contacts 22. Alternately, the signal contacts may be construed without any engaging portions, that is the linear portions 241 direct from the retaining sections 23.

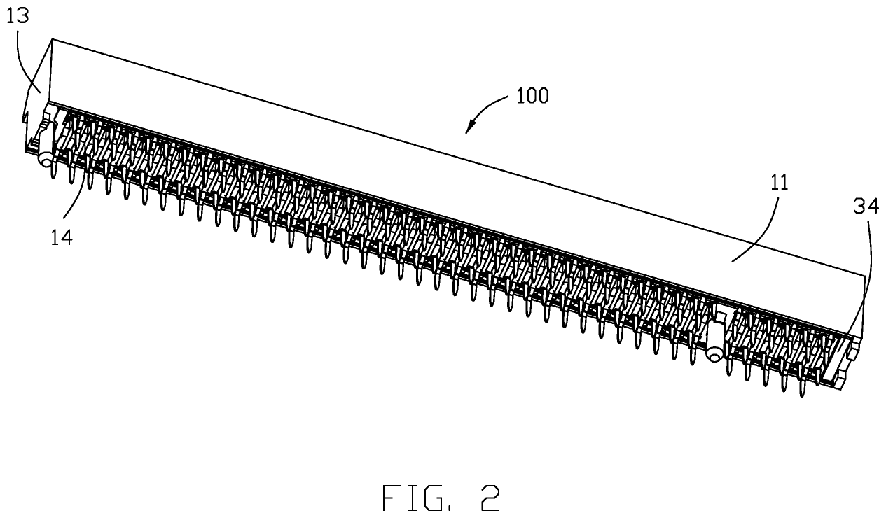

Referring to FIGS. 2 and 4, the two long plates 31 connect with two short plates 34 at opposite ends thereof. The short plates are attached on the bottom of the housing 1.

However, the disclosure is illustrative only, changes may be made in detail, especially in matter of shape, size, and arrangement of parts within the principles of the invention.

What is claimed is:

1. A card edge connector comprising:
an elongated housing comprising opposite long walls and defining a card slot between the long walls;
two rows of contacts retained in the long walls respectively and each row of contacts comprising ground contacts and signal contacts, the ground contacts comprising retaining sections retained in the housing, elastic sections extending upward from the retained sections with mating portions exposed to the card slot and leg sections extending downward from the retaining sections;
a ground member comprising two long plates retained in the long walls respectively;
wherein each of the ground contacts further comprises an engaging portion curved from the elastic section and touching corresponding long plate.

2. The card edge connector as claimed in claim 1, wherein each long plate defines a plurality of upright sections from an upper edge thereof and contacting with corresponding engaging sections of the ground contacts.

3. The card edge connector as claimed in claim 2, wherein each long plate defines at least one retaining rib from the upper edge thereof and retained in the long wall.

4. The card edge connector as claimed in claim 3, wherein the upright sections extend upward beyond the at least one retaining rib.

5. The card edge connector as claimed in claim 3, wherein the at least one retaining rib is located between two adjacent contacts along a transverse direction perpendicular to the long walls.

6. The card edge connector as claimed in claim 1, wherein the engaging portions extend from the retaining sections and slants toward corresponding long plates and the elastic sections continuously extend from the engaging sections.

7. The card edge connector as claimed in claim 1, wherein the elastic portion comprising the engaging portion extending from the retaining section, a linear portion extending from the engaging portion and the mating portion, the mating portion extending from the linear portion.

8. The card edge connector as claimed in claim 1, wherein each long wall defines a receiving slot opening downward and the long plate is received in the receiving slot from a bottom thereof.

9. A card edge connector comprising:
an insulating housing comprising opposite long walls and defining a card slot between the long walls;
at least one row of contacts retained in the long wall and the row of contacts comprising ground contacts and signal contacts, the ground contacts comprising retaining sections retained in the housing, elastic sections extending upward from the retained sections with mating portions exposed to the card slot and leg sections extending downward from the retaining sections;
at least one ground plate retained in the long wall;
wherein the elastic sections press against the ground plate and provide pivot points of the elastic sections rotating outward when a module is inserted in the card slot.

10. The card edge connector as claimed in claim 9, wherein the elastic section includes an engaging section slating outward from the retaining section, an linear section slanting inwards from the engaging section and the mating portion extending from the linear section, the engaging sections of the ground contacts press against the ground plate so as to provide said pivot point.

11. The card edge connector as claimed in claim 10, wherein the ground plate defines a plurality of upright sections from an upper edge thereof to engage with corresponding engaging sections of the ground contacts.

12. The card edge connector as claimed in claim 11, wherein the ground plate defines at least one retaining rib from the upper edge thereof and retained in the long wall.

13. A card edge connector for use with a memory module, comprising:
an elongated insulative housing including a pair of side walls extending along a longitudinal direction, and a pair of end walls linked between two opposite ends of said pair of side walls and extending in a transverse direction perpendicular to the longitudinal direction;
a card receiving slot formed among the pair of side walls and the pair of end walls for receiving the memory module;
two rows of passageways formed within the pair of side walls and communicating with the card receiving slot in the transverse direction;
two rows of contacts retained in the corresponding passageways, respectively, said contacts including grounding contacts and differential pair signal contacts alternately arranged with each other in the longitudinal direction and having similar configurations with each other, each contact including an immovable retaining section and a deflectable contacting section extending into the card receiving slot with an engaging portion therebetween;
a pair of grounding members retained in the housing, each of said grounding members forming a planar immoveable configuration in the housing and including a long bar extending continuously along and having a similar length with the corresponding side wall; and
the engaging portion of each grounding contact electrically and mechanically connect to the grounding member while the engaging portion of each signal contact abuts against the housing.

14. The card edge connector as claimed in claim 13, wherein a plurality of immovable upright sections unitarily extend upwardly from the corresponding long bar in a vertical direction perpendicular to both the longitudinal direction and the transverse direction so as to mechanically and electrically connect to the engaging portions of the corresponding grounding contacts, respectively.

15. The card edge connector as claimed in claim 14, wherein each side wall forms a receiving slot to receive the corresponding long bar, and a plurality of slits to receive the corresponding upright sections, respectively.

16. The card edge connector as claimed in claim 15, wherein each side wall forms a plurality of protrusions in the corresponding passageways, and the contacting section is outwardly deflected to abut against the corresponding protrusion when the memory module is received within the card receiving slot.

17. The card edge connector as claimed in claim 16, wherein the grounding members, the contacts and the housing are arranged to have the grounding members upwardly assembled into the housing before the contacts are upwardly assembled into the corresponding passageways, respectively.

18. The card edge connector as claimed in claim 13, wherein a width of the upright section is smaller than that of the engaging portion in the longitudinal direction.

19. The card edge connector as claimed in claim 13, wherein in each contact, viewed along a vertical direction perpendicular to both the longitudinal direction and the transverse direction, the contacting section and the engaging portion are located at opposite side of the retaining section in the transverse direction.

20. The card edge connector as claimed in claim 19, wherein the contacting section is higher than the engaging portion in the vertical direction.
